(19) United States
(12) Patent Application Publication
(10) Pub. No.: US 2019/0156265 A1
(43) Pub. Date: May 23, 2019

(54) SECTION PROCEDURE TRACKING SYSTEM AND SECTION PROCEDURE TRACKING SYSTEM METHOD

(71) Applicant: INSTITUTE FOR INFORMATION INDUSTRY, Taipei City (TW)

(72) Inventors: Ying-Hsun LAI, Tainan City (TW); Chin-Feng LAI, Kaohsiung City (TW); Yu-Cheng HSIAO, Taipei City (TW); Chi-Cheng CHUANG, Kaohsiung City (TW)

(73) Assignee: INSTITUTE FOR INFORMATION INDUSTRY, Taipei City (TW)

(21) Appl. No.: 15/834,645

(22) Filed: Dec. 7, 2017

(30) Foreign Application Priority Data
Nov. 22, 2017 (TW) 106140602

(51) Int. Cl. G06Q 10/06

(52) U.S. Cl. CPC G06Q 10/06395; G06Q 10/0633

(57) ABSTRACT

A section procedure tracking method comprises following steps: storing a plurality of process objects from a plurality of machines; calculating a plurality of basic process values according to a tension information, a length information, a speed information and a timing information of the process objects in a basic sequence; calculating an average basic value according to the basic process values; calculating a plurality of extra process values according to the tension information, the length information, the speed information and the timing information of the process objects in an extra sequence; calculating an average extra value according to the extra process values; selecting one of the average basic value and the average extra value having the smaller value; and selecting a search path corresponding to the smaller one of the average basic value and the average extra value as a process search order.

### CROSS-REFERENCE TO RELATED APPLICATION

This application claims priority to Taiwan Application Serial Number 106140602, filed Nov. 22, 2017, which is herein incorporated by reference.

### FIELD OF INVENTION

The present invention relates to a section procedure tracking system and a section procedure tracking method. More particularly, the present invention relates to a section procedure tracking system and a section procedure tracking method for applying to the manufacturing industry.

### DESCRIPTION OF RELATED ART

Many traditional industries, for example, the textile industry, need process many sections to complete the procurement of products. The sections can be, for example, preparing section, manufacturing section, weaving section, etc. However, if the products have defect, the problem may be found out when processing the quality control inspection. If the user wants to search which section causing the problem point, the user needs to trace back to find the factor causing the problem. Besides, it is possible that each machine for manufacturing different section using different method to manage the section process. As a result, it is very inconvenient to search from the current section to the forward sections. It is difficult to trace the problem.

If the user adopts manually recoding the product process, it is possible to fill the error data by human. Beside, manually recoding the product process needs to return the paper after a section is finished. If multiple sections have problem, it is hard to find the relation between the sections having problem when establishing data through paper.

Besides, some tracing system adopts linked list to write business logic, so as to link the data through linked list. However, there may have data or system compatibility issues between the factories making different sections. When adding a information system, the entire linked list needs to re-programming. In addition, it is very inconvenient to find the problems step-by-step.

Therefore, it is a problem desired to be solved in the industry that how to provide a section procedure tracking system and a section procedure tracking method suitable for searching problem point and establishing the tracing record step-by-step according to the different business demand.

### SUMMARY

Present disclosure provides a section procedure tracking system and a section procedure tracking method suitable for searching problem point and establishing the tracing record step-by-step according to the different business demand.

One aspect of the present disclosure is related to a section procedure tracking system. The section procedure tracking system comprises a storage device and a processing unit. The processing unit comprises a process tracing module. The storage device stores a plurality of process objects from a plurality of machines; wherein each the process object comprises a tension information, a length information, a speed information and a timing information. The process tracing module calculates a plurality of basic process values according to the tension information, the length information, the speed information and the timing information of the process objects in a basic sequence, calculates an average basic value according to the basic process values, calculate a plurality of extra process values according to the tension information, the length information, the speed information and the timing information of the process objects in an extra sequence, calculate an average extra value according to the extra process values and selects one of the average basic value and the average extra value having the smaller value and selects a search path corresponding to the smaller one of the average basic value and the average extra value as a process search order.

Another aspect of the present disclosure is related to a section procedure tracking method. In accordance with one embodiment of the present disclosure, the section procedure tracking method includes following steps: storing a plurality of process objects from a plurality of machines; wherein each the process object comprises a tension information, a length information, a speed information and a timing information by a storage device; calculating a plurality of basic process values according to the tension information, the length information, the speed information and the timing information of the process objects in a basic sequence, calculating an average basic value according to the basic process values by a processor; calculating a plurality of extra process values according to the tension information, the length information, the speed information and the timing information of the process objects in an extra sequence, calculating an average extra value according to the extra process values by the processor; and selecting one of the average basic value and the average extra value having the smaller value, selecting a search path corresponding to the smaller one of the average basic value and the average extra value as a process search order by the processor.

### BRIEF DESCRIPTION OF THE DRAWINGS

FIG. 1 is a schematic diagram of a section procedure tracking system according to one embodiment of the present invention.

FIG. 2 is a flowchart of a section procedure tracking method according to one embodiment of the present invention.

FIG. 3 is a flowchart of a section procedure tracking method according to one embodiment of the present invention.

FIG. 4 is a schematic diagram of a section procedure tracking method according to one embodiment of the present invention.

FIG. 5 is a schematic diagram of a section procedure tracking method according to one embodiment of the present invention.

### DETAILED DESCRIPTION OF DISCLOSED EMBODIMENTS

Reference will now be made in detail to the present embodiments of the invention, examples of which are illustrated in the accompanying drawings. Wherever possible, the same reference numbers are used in the drawings and the description to refer to the same or like parts.

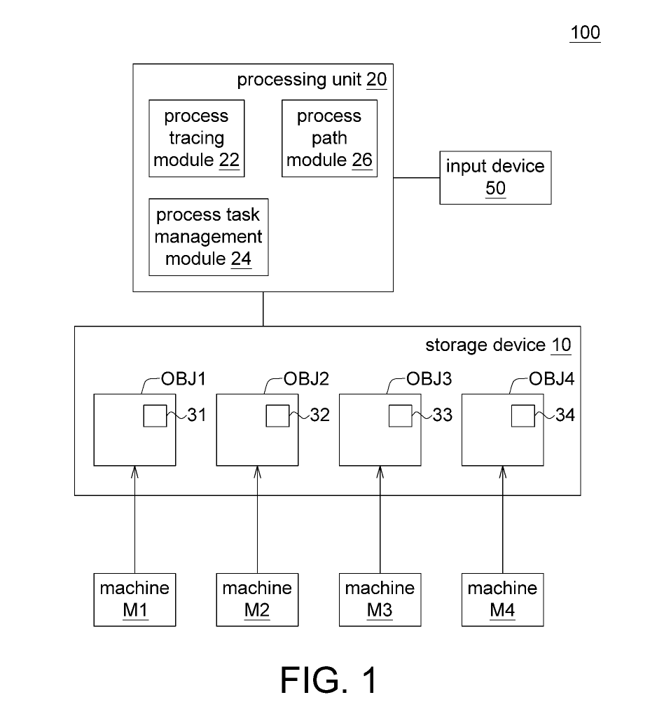

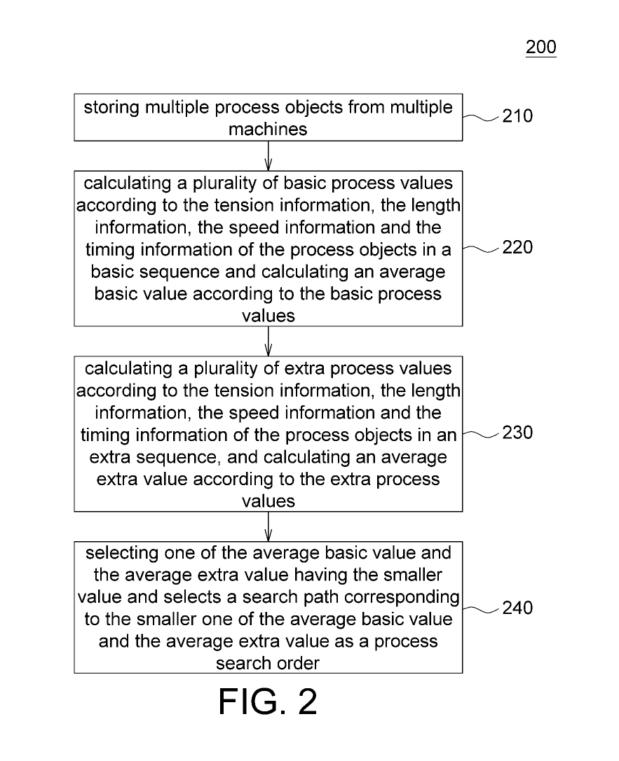

Reference is made to FIGS. 1-2. FIG. 1 is a schematic diagram of a section procedure tracking system 100 according to one embodiment of the present invention. FIG. 2 is a flowchart of a section procedure tracking method 200 according to one embodiment of the present invention. In one embodiment, section procedure tracking system 100 comprises a storage device 10 and a processing unit 20. The processing unit 20 comprises a process tracing module 22. In one embodiment, the processing unit 20 further comprises a process task management module 24 and a process path module 26. In one embodiment, the processing unit 20 couples to an input device 50 by wire or wireless connection method. In one embodiment, the storage device 10 couples to multiple machines M1-M4 by wire or wireless connection method.

In one embodiment, the storage device 10 and the processing unit 20 can be configured in a notebook, a desktop, a smart phone, a panel or other device with displaying function. In one embodiment, the input device 50 can be a keyboard, a touch screen or other electronic device having an input function for user inputting information.

In one embodiment, the processing unit 20 can be implemented by a microcontroller, a microprocessor, a digital signal processor, an application specific integrated circuit (ASIC), or a logic circuit. In one embodiment, the process tracing module 22, the process task management module 24 and the process path module 26 can be implemented separately or combined by a microcontroller, a microprocessor, a digital signal processor, an application specific integrated circuit (ASIC), or a logic circuit.

In one embodiment, as shown in FIG. 1, the machines M1-M4 are responsible for the various sections when making objects. Each machine M1-M4 transfers the multiple process records generating during the manufacturing process to the process objects OBJ1-OBJ4 and stores the process objects OBJ1-OBJ4 to the storage device 10. Each process object OBJ1-OBJ4 corresponding to each object class 31-34. Each object class 31-34 store in the each process object OBJ1-OBJ4 corresponding to each machine M1-M4.

For example, machines M1-M4 use for dealing with the sections of weaving fabric and transmitting the process object OBJ1-OBJ4 to the storage device 10. For instance, the machine M1 is the warping machine, the machine M2 is the warp sizing machine. The warping machine can generate multiple process records during operation. The process records include tension, processing speed, length and/or error checking. The set of all the process records outputted by machine M1 is defined as process object OBJ1. The process object OBJ1 includes object class 31 (e.g., the warping class). On another hand, the warp sizing machine also generates multiple process records during operation. The process records generated by the warp sizing machine includes tension, processing speed, size concentration and/or temperature. The set of all the process records outputted by machine M2 is defined as process object OBJ2. The process object OBJ2 includes object class 32 (e.g., the warp sizing class). Similarly, the machines M3-M4 execute different sections. It is not further described herein.

In one embodiment, as shown in FIG. 2, the detail of the flowchart of the section procedure tracking method 200 is described as follows. The component mentioned in the section procedure tracking method 200 can be implemented by the component describing in FIG. 1.

In step 210, the storage device 10 stores multiple process objects OBJ1-OBJ4 from multiple machines M1-M4. Each the process object OBJ1-OBJ4 comprises a tension information, a length information, a speed information and a timing information.

In one embodiment, the machines M1-M4 separately are warping machine, warp sizing machine, warp combining machine, weaving machine. And, the machines M1-M4 separately generate the process object OBJ1 of the warping, the process object OBJ2 of the warp sizing, the process object OBJ3 of the warp combining, the process object OBJ4 of weaving. Each process object OBJ1-OBJ4 comprises tension information, length information, speed information and timing information.

In one embodiment, processing unit 20 further comprises a process task management module 24. The process task management module 24 can be implemented by a microcontroller, a microprocessor, a digital signal processor, an application specific integrated circuit (ASIC), or a logic circuit. The process task management module 24 receives a key from the process tracing module 26 the according to a machine number, an object class and an object number of at least one of the machines M1-M4 after the process tracing module 22 transmits an apply signal to the process task management module 26. The process tracing module 22 decrypts an encrypted tension information, an encrypted length information, an encrypted speed information and an encrypted timing information of at least one of the process objects OBJ1-OBJ4 by the key.

In step 220, the process tracing module 22 (e.g., the process tracing module 22 can be implemented by a processor) calculates a plurality of basic process values according to the tension information, the length information, the speed information and the timing information of the process objects in a basic sequence and calculates an average basic value according to the basic process values.

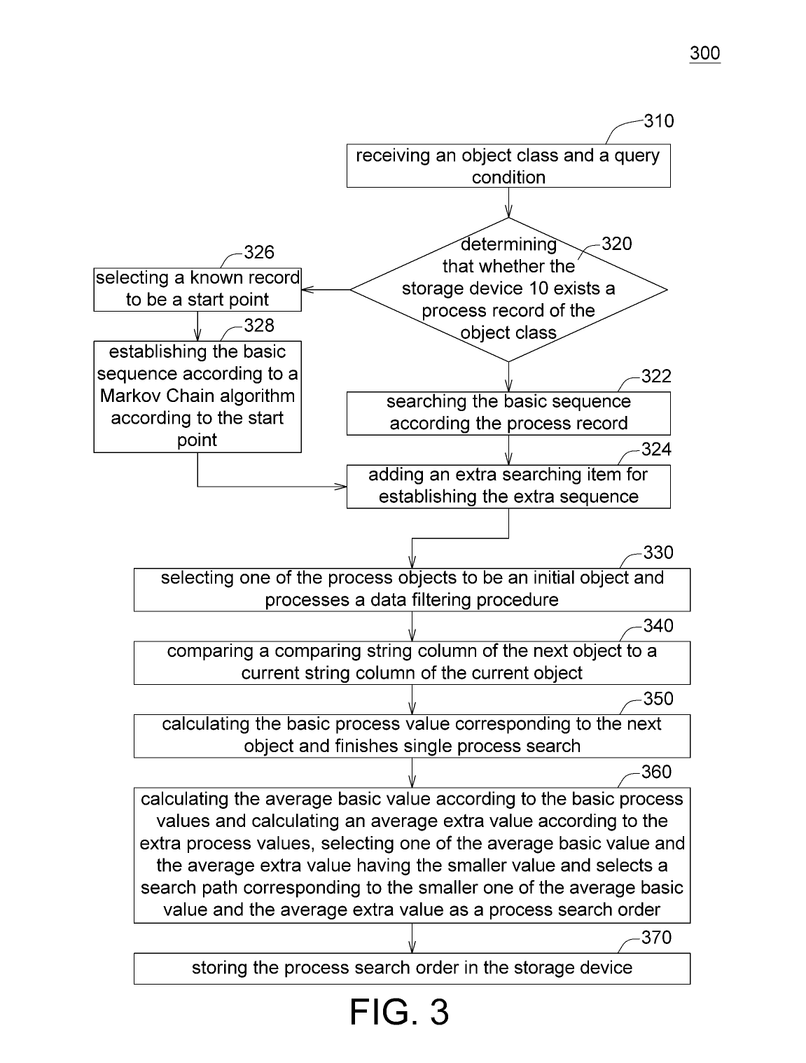

In one embodiment, the basic sequence stores in storage device 10. The calculation method of the basic process values will be described corresponding to FIG. 3.

In step 230, the process tracing module 22 calculates a plurality of extra process values according to the tension information, the length information, the speed information and the timing information of the process objects in an extra sequence, and calculates an average extra value according to the extra process values.

In one embodiment, the extra sequence stores in storage device 10. The calculation method of the basic process values will be described corresponding to FIG. 3.

In step 240, the process tracing module 22 selects one of the average basic value and the average extra value having the smaller value and selects a search path corresponding to the smaller one of the average basic value and the average extra value as a process search order.

Reference is made to FIG. 3. FIG. 3 is a flowchart of a section procedure tracking method 300 according to one embodiment of the present invention.

In step 310, the input device 50 receives an object class (e.g., object class 31) and a query condition.

In one embodiment, the input device 50 is a keyboard. The user can use the keyboard to input an object class (e.g., object class 31 is warping class) and a query condition (e.g., Oct. 10, 2017-Oct. 11, 2017).

In one embodiment, the processing unit 20 further comprises process tracing module 26. The process tracing module 26 receives a edit information to assign the search path to the process tracing module 22 (e.g., sequentially searching warp sizing class, weaving class and warping class). The process tracing module 26 can be implemented separately or combined by a microcontroller, a microprocessor, a digital signal processor, an application specific integrated circuit (ASIC), or a logic circuit.

In step 320, the process tracing module 22 determines that whether the storage device 10 exists a process record of the object class (e.g., object class 31 is warping class). If the storage device 10 exists the process record of the object class, step 322 is performed. If the storage device 10 does not exist the process record of the object class, step 326 is performed.

In one embodiment, if the object class (e.g., object class 31 is warping class) is searched by user, the process record of the object class 31 is stored in the storage device 10. Otherwise, the process record of the object class 31 is not stored in the storage device 10.

In one embodiment, section procedure tracking system 100 comprises multiple process tracing module 22. The process tracing module 22 can process the operation of searching the object classes 31-34 in parallel.

In step 322, the process tracing module 22 searches the basic sequence according the process record.

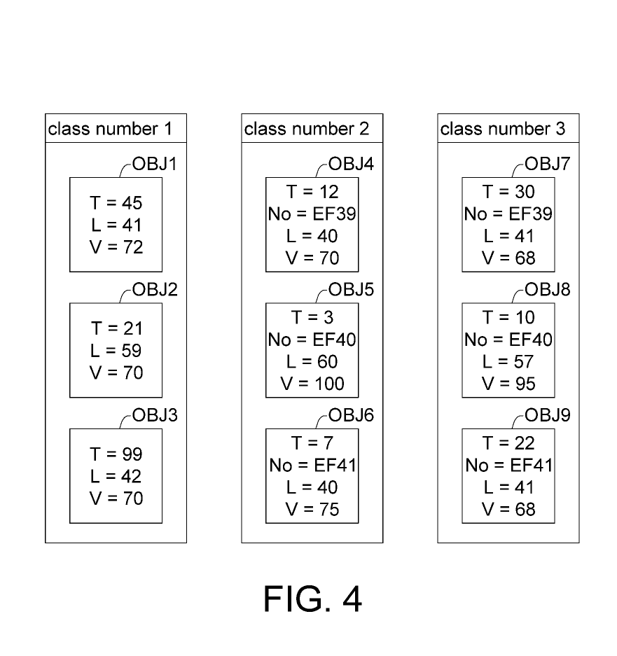

Reference is made to FIG. 4. FIG. 4 is a schematic diagram of a section procedure tracking method according to one embodiment of the present invention. In one embodiment, when the query condition is Oct. 10, 2017-Oct. 11, 2017 and the user wants to sequentially search the process record of warp sizing class (class number 2), warp combining class (class number 3) and warping class (class number 1) of the preparing section, the process tracing module 22 searches the preparing section in the basic sequence according to the process record. If the process tracing module 22 finds the process record of the warp sizing class (class number 2), the warp combining class (class number 3) and the warping class (class number 1) generated from a factory area, the process tracing module 22 regards the process record of the warp sizing class (class number 2), the warp combining class (class number 3) and the warping class (class number 1) as the basic sequence.

In step 324, the process tracing module 22 adds an extra searching item which is generated randomly to the basic sequence for establishing the extra sequence.

In one embodiment, when the basic sequence is the warp sizing class (class number 2), the warp combining class (class number 3) and the warping class (class number 1), the process tracing module 22 adds an extra searching item which is generated randomly, for example, weaving class (class number 4), to the basic sequence for establishing the extra sequence. This extra sequence includes the warp sizing class (class number 2), the warp combining class (class number 3), the warping class (class number 1) and weaving class (class number 4).

Thus, by searching the basic sequence and further searching an extra sequence, it can increase the possibility for the process tracing module 22 finding a search path better than the basic sequence.

In step 326, the process tracing module 22 selects a known record to be a start point.

In one embodiment, the process tracing module 22 prepares searching the process record of the preparing section. However, the process tracing module 22 only establishes the process record of manufacturing section, previously. Therefore, the process tracing module 22 configures the process record of manufacturing section (a known record) to be a start point for searching.

In step 328, the process tracing module 22 establishes the basic sequence according to a Markov Chain algorithm according to the start point.

In one embodiment, the process tracing module 22 speculates the next causing sequence (e.g., preparing section) by the start point (e.g., manufacturing section) according to a Markov Chain algorithm. Due to the Markov Chain algorithm is a known algorithm, it is no more described herein.

After step 328 is finished, the step 324 is performed. The step 324 is described in previous statements. Therefore, it is no more described herein.

In step 330, as shown in FIG. 4, the process tracing module 22 selects one of the process objects OBJ1-OBJ9 to be an initial object (e.g., process object OBJ4) and processes a data filtering procedure from an initial time point when the initial object is generated and searches the process objects (e.g., process objects OBJ1-OBJ4, OBJ7, OBJ9) having a corresponding time point is larger than or equal to the initial time point.

To be more specifically, as shown in Fig.4, the process object OBJ4 is generated at initial time point T. And, the initial time point T of the process object OBJ4 is 12. The initial time point T of process objects OBJ1-OBJ4, OBJ7, OBJ9 are larger than or equal to 12. Thus, process objects OBJ1-OBJ4, OBJ7, OBJ9 are substituted into step 340. Other process objects OBJ5-OBJ6, OBJ8 are filtered.

In step 340, the process tracing module 22 compares a comparing string column of the next object to a current string column of the current object.

In one embodiment, after the process tracing module 22 performs the data filtering procedure, the process tracing module 22 obtains a part of the process objects OBJ1-OBJ4, OBJ7, OBJ9. The part of the process objects OBJ1-OBJ4, OBJ7, OBJ9 comprises a current object (e.g., process object OBJ4) and a next object. An initial time point of the next object is larger than or equal to an initial time point of the current object. The process tracing module 22 determines that whether a comparing string column of the next object is consistent with a current string column of the current object. If the comparing string column of the next object is consistent with the current string column of the current object, the process tracing module 22 selects the next object firstly.

For example, when the basic sequence is the process record of warp sizing class (class number 2), warp combining class (class number 3) and warping class (class number 1), the process tracing module 22 determines that whether the process object OBJ 4 (current object) of the warp sizing class (class number 2) having the same string column with the process objects OBJ7-OBJ9 of the warp combining class (class number 3). In this case, the process object OBJ 4 (current object) comprises string “No=EF39”. The process object OBJ 7 (the next object) of warp combining class (class number 3) comprises the same string “No=EF39”. Therefore, the process tracing module 22 selects the process object OBJ7 (the next object) firstly. And, the process tracing module 22 substitutes the process object OBJ to the calculation in step 350.

In one embodiment, when the comparing string columns of all the next objects are different from the current string column of the current object, the step 340 is skipped. The step 350 is performed directly. The calculation method of step 350 selects the next object having the smallest basic process value.

In step 350, the process tracing module 22 calculates the basic process value corresponding to the next object (e.g., process object OBJ7) and finishes single process search.

In one embodiment, after the process tracing module 22 processes the data filtering procedure (step 330), the process tracing module 22 obtains the process objects OBJ1-OBJ4, OBJ7, OBJ9 in the basic sequence. The process objects OBJ1-OBJ4, OBJ7, OBJ9 comprises a current object (e.g., process object OBJ4) and a plurality of next objects (e.g., process objects OBJ1-OBJ3, OBJ7, OBJ9). A plurality of initial time points of the next objects (e.g., process objects OBJ1-OBJ3, OBJ7, OBJ9) are larger than or equal to an initial time point of the current object (e.g., process object OBJ4). The process tracing module 22 calculates a tension difference, a length difference, a speed difference and a time difference between each next object (e.g., each process object OBJ1-OBJ3, OBJ7, OBJ9) and the current object (e.g., process object OBJ4), and separately calculates and sums up the absolute value of the tension difference (in this example, assume each process object OBJ1-OBJ3, OBJ7, OBJ having the same tension difference, thus, the tension difference is not shown in FIG. 4), the length difference L, the speed difference V and the time difference T between each next object and the current object to obtain a first result between each next object (e.g., each process object OBJ1-OBJ3, OBJ7, OBJ9) and the current object (e.g., process object OBJ4), and multiply the first result by the time difference T between each next object and the current object, so as to obtain the basic process values.

After each round of the calculation for basic process values, the process tracing module 22 selects the process object having the smallest basic process value (e.g., process object OBJ7) with the current object (e.g., process object OBJ4) to be the next object.

To be more specifically, as shown in Fig.4, assume the basic sequence is warp sizing class (class number 2), warp combining class (class number 3) and warping class (class number 1), according to the order of class number 2, class number 3 and class number 1, the process tracing module 22 selects the process object (e.g., the process object OBJ7 belonging to the class number 3) having the smallest basic process value with the current object (e.g., the process object OBJ4 belonging to the class number 2) to be the next object. Then, the process tracing module 22 selects the process object (e.g., the process object OBJ1 belonging to the class number 3) having the smallest basic process value with the current object (e.g., the process object OBJ7 belonging to the class number 3) to be the next object, and the process tracing module 22 sequentially generates the basic process value S1, S2 and S3.

In this case, when the current object is process object OBJ4 and the next object is process object OBJ7 (due to the process object OBJ7 of class number 3 having the smallest basic process value with process object OBJ4, the next object is determined as process object OBJ7), the tension difference, the length difference, the speed difference and the time difference between the process object OBJ7 and process object OBJ4 are calculated to obtain a first result between the process object OBJ7 and process object OBJ4, and multiply the first result by the time difference between the process object OBJ7 and process object OBJ4, so as to obtain the first process values. Next, when the current object is process object OBJ7 and the next object is process object OBJ1 (due to the process object OBJ1 of class number 1 having the smallest basic process value with process object OBJ7, the next object is determined as process object OBJ1), the tension difference, the length difference, the speed difference and the time difference between the process object OBJ1 and process object OBJ7 are calculated to obtain a first result between the process object OBJ7 and process object OBJ1, and multiply the second result by the time difference between the process object OBJ7 and process object OBJ1, so as to obtain the second process values. The process tracing module 22 adds the first process values and the second process values to obtain an calculation result and then divides the calculation result by two (because two process objects OBJ1 and OBJ7 are calculated), so as to obtain the basic process value S1. As such, the basic process value S1 is:

S1={(|41−40|+|68−70|)*(30−12)+(|41−41|+|72−68|)*(45−30)}/2=54.

After this round, the process object OBJ1, OBJ4 and OBJ7 selected when calculating the basic process value S1 will not be calculated again when calculating the basic process value S2 and S3.

Next, when the current object is process object OBJ5 and the next object is process object OBJ8 (due to the process object OBJ8 of class number 3 having the smallest basic process value with process object OBJ5, the next object is determined as process object OBJ8), the tension difference, the length difference, the speed difference and the time difference between the process object OBJ5 and process object OBJ8 are calculated to obtain a third result between the process object OBJ5 and process object OBJ8, and multiply the third result by the time difference between the process object OBJ5 and process object OBJ8, so as to obtain the third process values. Next, when the current object is process object OBJ8 and the next object is process object OBJ2 (due to the process object OBJ2 of class number 1 having the smallest basic process value with process object OBJ8, the next object is determined as process object OBJ2), the tension difference, the length difference, the speed difference and the time difference between the process object OBJ2 and process object OBJ8 are calculated to obtain a fourth result between the process object OBJ2 and process object OBJ8, and multiply the fourth result by the time difference between the process object OBJ2 and process object OBJ8, so as to obtain the fourth process values. The process tracing module 22 adds the third process values and the fourth process values to obtain an calculation result and then divides the calculation result by two (because two process objects OBJ2 and OBJ8 are calculated), so as to obtain the basic process value S2. As such, the basic process value S2 is:

S2={(|57−60|+|95−100|)*(10−3)+(|59−57|+|98−95|)*(21−10)}/2=(56+55)/2=55.5.

After this round, the process object OBJ2, OBJ5 and OBJ8 selected when calculating the basic process value S2 will not be calculated again when calculating the basic process value S3.

Next, when the current object is process object OBJ6 and the next object is process object OBJ9 (due to the process object OBJ9 of class number 3 having the smallest basic process value with process object OBJ6, the next object is determined as process object OBJ9), the tension difference, the length difference, the speed difference and the time difference between the process object OBJ9 and process object OBJ6 are calculated to obtain a fifth result between the process object OBJ9 and process object OBJ6, and multiply the fifth result by the time difference between the process object OBJ9 and process object OBJ6, so as to obtain the fifth process values. Next, when the current object is process object OBJ9 and the next object is process object OBJ3 (due to the process object OBJ3 of class number 1 having the smallest basic process value with process object OBJ9, the next object is determined as process object OBJ3), the tension difference, the length difference, the speed difference and the time difference between the process object OBJ3 and process object OBJ9 are calculated to obtain a fourth result between the process object OBJ3 and process object OBJ9, and multiply the sixth result by the time difference between the process object OBJ3 and process object OBJ9, so as to obtain the sixth process values. The process tracing module 22 adds the fifth process values and the sixth process values to obtain an calculation result and then divides the calculation result by two (because two process objects OBJ3 and OBJ9 are calculated), so as to obtain the basic process value S3. As such, the basic process value S3 is:

S3={(|41−40|+|68−75|)*(22−7)+(|42−41|+|70−68|)*(99−22)}/2=(120+154)/2=137.

After this round, the process object OBJ2, OBJ5 and OBJ8 selected when calculating the basic process value S2 will not be calculated again when calculating the basic process value S3.

After calculating the basic process values S1-S3, a single process search is finished.

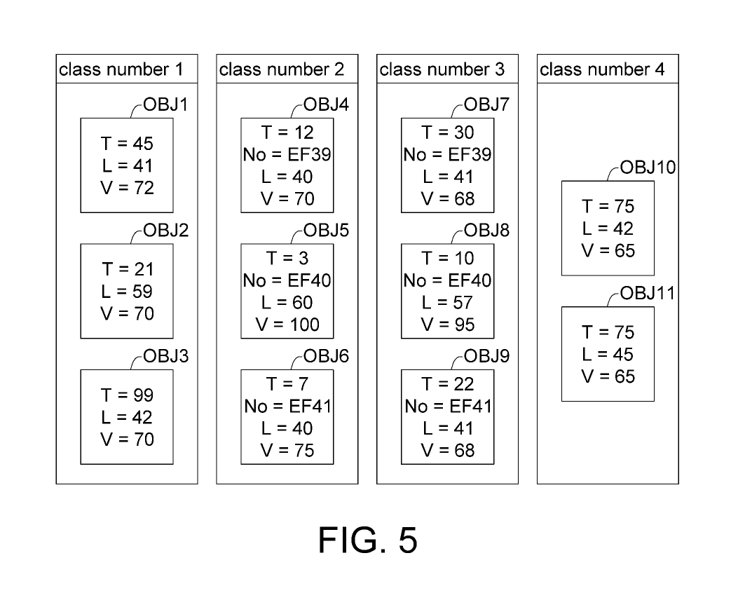

In another aspect, before performing step 360, please refer to FIG. 5. FIG. 5 is a schematic diagram of a section procedure tracking method according to one embodiment of the present invention. The difference between FIG. 4 and FIG. 5 is that FIG. 5 further comprises an extra searching item (class number 4). The process objects OBJ10-OBJ11 belongs to class number 4. The extra sequence established by the process tracing module 22 sequentially comprises the warp sizing class (class number 2), the warp combining class (class number 3), the warping class (class number 1) and weaving class (class number 4). However, the insert position of the weaving class (class number 4) can be arranged randomly, not limited to this example.

Similarly, the process tracing module 22 calculates a plurality of extra process values according to the tension information, the length information, the speed information and the timing information of the process objects in an extra sequence, and calculates an average extra value according to the extra process values. The process tracing module 22 selects one of the average basic value and the average extra value having the smaller value, selecting a search path corresponding to the smaller one of the average basic value and the average extra value as a process search order.

To be more specifically, the process tracing module 22 can substitute the extra sequence into step 330, the after the process tracing module 22 processes the data filtering procedure, the process tracing module obtains the process objects in the extra sequence. The process objects comprises a current object and a plurality of next objects; a plurality of initial time points of the next objects are larger than or equal to an initial time point of the current object (step 340). The process tracing module 22 calculates a tension difference, a length difference, a speed difference and a time difference between each next object and the current object, and separately calculates and sums up the absolute value of the tension difference, the length difference, the speed difference and the time difference between each next object and the current object to obtain a first result between each next object and the current object, and multiply the first result by the time difference between each next object and the current object to obtain a first process value, and adds the first process values and a second process values to obtain an calculation result and then divides the calculation result by two, so as to obtain the extra process values S1′-S3′ (step 350). The process tracing module 22 calculates an average extra value SA′ according to the extra process values S1′-S3′.

The tracing method of the extra sequence is similar with the basic sequence, the difference is that the extra sequence searches more extra search item (class number 4), and the detail is not further mentioned herein. The following paragraphs provides the calculation corresponding to the extra process value S1′-S3′ and average extra value SA′ in FIG. 5. The determining steps are similar with the basic sequence, and thus no further description will be given.

In FIG. 5, the extra process value S1′ can be generated by process objects OBJ4, OBJ7, OBJ1 and OBJ10. The calculation method is:

S1′={(|41−40|+|68−70|)*(30−12)+(|41−41|+|72−68|)*(45−30)+(|42−41|+|72−65|)*(75−45)}/3=(48+60+210)/3=106.

The extra process value S2′ can be generated by process objects OBJ2, OBJ5, OBJ8 and OBJ11. The calculation method is:

S2′={(|57−60|+|95−100|)*(10−3)+(|59−57|+|98−95|)*(21−10)+(|45−59|+|65−98|))*(75−21)}/3=(56+55+2538)/3=883.

The extra process value S3′ can be generated by process objects OBJ6, OBJ9 and OBJ3. The calculation method is:

S3′={(|41−40|+|68−75|)*(22−7)+(|42−41|+|70−68|)*(99−22)}=(120+154)/2=137.

After calculating the extra process values S1′-S3′, a single process search is finished.

In step 360, the process tracing module 22 calculates the average basic value SA according to the basic process values S1-S3 and calculates an average extra value SA′ according to the extra process values SA′. The process tracing module 22 selects one of the average basic value SA and the average extra value SA′ having the smaller value and selects a search path corresponding to the smaller one of the average basic value SA and the average extra value SA′ as a process search order.

According to above example, the calculation method of average basic value SA is:

SA=(54+55.5+137)/3=82.17.

The calculation method of average extra value SA′ is:

SA′=(106+883+137)/3=375.3.

The average basic value SA is smaller than the average extra value SA′. Therefore, the process tracing module 22 selects the search path corresponding to the average basic value SA to be the process search order.

In step 370, the process tracing module 22 stores the process search order in the storage device 10.

Based on above, the section procedure tracking system and the section procedure tracking method can be applied in the field of textile industry, dyeing-finishing industry, printing industry and/or other manufacturing industry. The section procedure tracking system and the section procedure tracking method can obtain all the process record of all the machines and establish the process search order according to the tension information, the length information, the speed information and the timing information of each process object. Therefore, each factory can establish the tracing record step-by-step, so as to increase the flexibility of extension and enhance searching speed of the section procedure tracking system.

Although the present invention has been described in considerable detail with reference to certain embodiments thereof, other embodiments are possible. Therefore, the scope of the appended claims should not be limited to the description of the embodiments contained herein.

What is claimed is:

1. A section procedure tracking system, comprising:
a storage device configured to store a plurality of process objects from a plurality of machines; wherein each the process object comprises a tension information, a length information, a speed information and a timing information; and
a processing unit, comprising:
a process tracing module configured to calculate a plurality of basic process values according to the tension information, the length information, the speed information and the timing information of the process objects in a basic sequence, calculate an average basic value according to the basic process values, calculate a plurality of extra process values according to the tension information, the length information, the speed information and the timing information of the process objects in an extra sequence, calculate an average extra value according to the extra process values, and select one of the average basic value and the average extra value having the smaller value; and selecting a search path corresponding to the smaller one of the average basic value and the average extra value as a process search order.

2. The section procedure tracking system of claim 1, wherein the process tracing module selects one of the process objects to be an initial object, processes a data filtering procedure from an initial time point when the initial object is generated, and searches the process objects having a corresponding time point is larger than or equal to the initial time point.

3. The section procedure tracking system of claim 2, further comprising:
an input device configured to receive an object class and a query condition;
wherein the process tracing module determines that whether the storage device exists a process record of the object class;
if the process tracing module determines that the storage device exists the process record of the object class, the process tracing module searches the basic sequence according to the process record;
if the process tracing module determines that the storage device does not exist the process record of the object class, the process tracing module configures a known record to be a start point and establishes the basic sequence according to a Markov Chain algorithm according to the start point.

4. The section procedure tracking system of claim 2, wherein the process tracing module adds an extra searching item which is generated randomly to the basic sequence for establishing the extra sequence.

5. The section procedure tracking system of claim 2, wherein after the process tracing module processes the data filtering procedure, the process tracing module obtains a part of the process objects; the part of the process objects comprises a current object and a next object; an initial time point of the next object is larger than or equal to an initial time point of the current object; the process tracing module determines that whether a comparing string column of the next object is consistent with a current string column of the current object; if the comparing string column of the next object is consistent with the current string column of the current object, the process tracing module selects the next object firstly, and calculates a basic process value corresponding to the next object.

6. The section procedure tracking system of claim 2, wherein after the process tracing module processes the data filtering procedure, the process tracing module obtains the process objects in the basic sequence; the process objects comprises a current object and a plurality of next objects; a plurality of initial time points of the next objects are larger than or equal to an initial time point of the current object; the process tracing module calculates a tension difference, a length difference, a speed difference and a time difference between each next object and the current object, and separately calculates and sums up the absolute value of the tension difference, the length difference, the speed difference and the time difference between each next object and the current object to obtain a first result between each next object and the current object, and multiply the first result by the time difference between each next object and the current object to obtain a first process value, and adds the first process values and a second process values to obtain an calculation result and then divides the calculation result by two, so as to obtain the basic process values.

7. The section procedure tracking system of claim 2, wherein after the process tracing module processes the data filtering procedure, the process tracing module obtains the process objects in the extra sequence; the process objects comprises a current object and a plurality of next objects; a plurality of initial time points of the next objects are larger than or equal to an initial time point of the current object; the process tracing module calculates a tension difference, a length difference, a speed difference and a time difference between each next object and the current object, and separately calculates and sums up the absolute value of the tension difference, the length difference, the speed difference and the time difference between each next object and the current object to obtain a first result between each next object and the current object, and multiply the first result by the time difference between each next object and the current object to obtain a first process value, and adds the first process values and a second process values to obtain an calculation result and then divides the calculation result by two, so as to obtain the extra process values.

8. The section procedure tracking system of claim 2, wherein process tracing module stores the process search order to the storage device.

9. The section procedure tracking system of claim 2, wherein the processing unit further comprising:
a process task management module configured to receive a key from the process tracing module according to a machine number, an object class and an object number of at least one of the machines after the process tracing module transmitting an apply signal to the process task management module; wherein the process tracing module decrypts an encrypted tension information, an encrypted length information, an encrypted speed information and an encrypted timing information of at least one of the process objects by the key.

10. The section procedure tracking system of claim 1, wherein the processing unit further comprising:
a process path module configured to receive a user edit information to assign the search path to the process tracing module.

11. A section procedure tracking method, comprising:
storing a plurality of process objects from a plurality of machines; wherein each the process object comprises a tension information, a length information, a speed information and a timing information by a storage device;
calculating a plurality of basic process values according to the tension information, the length information, the speed information and the timing information of the process objects in a basic sequence, calculating an average basic value according to the basic process values by a processor;
calculating a plurality of extra process values according to the tension information, the length information, the speed information and the timing information of the process objects in an extra sequence, calculating an average extra value according to the extra process values by the processor; and
selecting one of the average basic value and the average extra value having the smaller value, selecting a search path corresponding to the smaller one of the average basic value and the average extra value as a process search order by the processor.

12. The section procedure tracking method of claim 11, further comprising:
selecting one of the process objects to be an initial object, processes a data filtering procedure from an initial time point when the initial object is generated; and
searching the process objects having a corresponding time point is larger than or equal to the initial time point.

13. The section procedure tracking method of claim 12, further comprising:
receiving an object class and a query condition by the processor; and
determining whether the storage device exists a process record of the object class by the processor;
if the processor determines that the storage device exists the process record of the object class, the processor searches the basic sequence according to the process record;
if the processor determines that the storage device does not exist the process record of the object class, the processor configures a known record to be a start point and establishes the basic sequence according to a Markov Chain algorithm according to the start point.

14. The section procedure tracking method of claim 12, further comprising:
adding an extra searching item which is generated randomly to the basic sequence for establishing the extra sequence by the processor.

15. The section procedure tracking method of claim 12, wherein after processor processing the data filtering procedure, the processor obtains a part of the process objects; the part of the process objects comprises a current object and a next object; an initial time point of the next object is larger than or equal to an initial time point of the current object; the processor determines that whether a comparing string column of the next object is consistent with a current string column of the current object; if the comparing string column of the next object is consistent with the current string column of the current object, the processor selects the next object firstly, and calculates a basic process value corresponding to the next object.

16. The section procedure tracking method of claim 12, wherein after the processor processes the data filtering procedure, the processor obtains the process objects in the basic sequence; the process objects comprises a current object and a plurality of next objects; a plurality of initial time points of the next objects are larger than or equal to an initial time point of the current object; the processor calculates a tension difference, a length difference, a speed difference and a time difference between each next object and the current object, and separately calculates and sums up the absolute value of the tension difference, the length difference, the speed difference and the time difference between each next object and the current object to obtain a first result between each next object and the current object, and multiply the first result by the time difference between each next object and the current object to obtain a first process value, and adds the first process values and a second process values to obtain an calculation result and then divides the calculation result by two, so as to obtain the basic process values.

17. The section procedure tracking method of claim 12, wherein after the processor processes the data filtering procedure, the processor obtains the process objects in the extra sequence; the process objects comprises a current object and a plurality of next objects; a plurality of initial time points of the next objects are larger than or equal to an initial time point of the current object; the processor calculates a tension difference, a length difference, a speed difference and a time difference between each next object and the current object, and separately calculates and sums up the absolute value of the tension difference, the length difference, the speed difference and the time difference between each next object and the current object to obtain a first result between each next object and the current object, and multiply the first result by the time difference between each next object and the current object to obtain a first process value, and adds the first process values and a second process values to obtain an calculation result and then divides the calculation result by two, so as to obtain the extra process values.

18. The section procedure tracking method of claim 12, further comprising:
storing the process search order to the storage device by the processor.

19. The section procedure tracking method of claim 12, further comprising:
receiving a key according to a machine number, an object class and an object number of at least one of the machines from the processor; and
decrypting an encrypted tension information, an encrypted length information, an encrypted speed information and an encrypted timing information of at least one of the process objects by the key.

20. The section procedure tracking method of claim 11, further comprising:
receiving a user edit information to assign the search path to the processor.
